(19) United States
(12) Patent Application Publication
(10) Pub. No.: US 2008/0043143 A1
(43) Pub. Date: Feb. 21, 2008

(54) Mobile audio-video receiver with movable display

(75) Inventor: Suk Ki Hong, Tustin, CA (US)

Correspondence Address: SEYFARTH SHAW, LLP, 815 CONNECTICUT AVENUE, N.W., SUITE 500, WASHINGTON, DC, 20006, US

(73) Assignee: NESA International Incorporated, Santa Fe Springs, CA (US)

(21) Appl. No.: 11/506,885

(22) Filed: Aug. 21, 2006

(51) Int. Cl. H04N 11/00

(52) U.S. Cl. 348/468; 455/425

(57) ABSTRACT

A mobile audio-video receiver with a movable display includes: a base for containing circuitry; a front surface of the base defined by a first long side of the base having a first direction, a second long side of the base opposite to the first long side and having a second direction, a first short side of the base and a second short side of the base opposite to the first short side; and a door-display having a first display screen and hingedly attached to the base with a first hinge axis crossing the first and second directions.

### BACKGROUND OF THE INVENTION

1. Field of The Invention

The present invention relates to a mobile audio-video receiver, and more particularly, to a mobile audio-video receiver with a movable display. Although the present invention is suitable for a wide scope of applications, it is particularly suitable for improving the viewing position of a display on a mobile audio-video receiver.

2. Discussion of The Related Art

In general, a related art mobile audio-video receiver includes a control panel with a display screen for displaying an image, audio outputs for providing audio signals to speakers and internal memory for storing data to support functions of the mobile audio-video receiver. The receiver can function as a navigation system that is used to find a destination or other points of interest. The related art receiver can also function as a sound system using internal audio players within the receiver, such as an MP3 player, a WAV player or a compact disk player. Other types of external audio players can be attached to the receiver through an audio input port or a data input port configured for receiving signals from a predetermined device, such as an external compact disk changer. Further, the related art receiver can function as a audio/video system using internal audio/video players within the receiver, such as an MPEG player, a WMA player or a digital-video-disk (DVD) player. Other types of external audio/video players can be attached to the related receiver through an audio/video input port or a data input port configured for receiving signals from a predetermined device, such as an external digital video disk changer. Furthermore, the functions of the related art audio-video receiver can also include television and FM/AM radio.

Typically, a related art mobile audio-video receiver is mounted in the dash of a transport vehicle, such as a car, truck, recreational vehicle, boat or airplane. In addition or in the alternative, the related art mobile audio-video receiver can be mounted in other areas of a transport vehicle. However, the related art mobile audio-video receiver is usually mounted in the dash between where the driver is positioned and where a passenger can be positioned. Such a mounting position allows both the driver and the passenger to view a display screen on the related art mobile audio-video receiver as well as to operate the related art mobile audio-video receiver.

FIG. 1 is a front view of a related art mobile audio-video receiver with a front-face display. As shown in FIG. 1, the mobile audio-video receiver 100 includes a base 101 having a double-DIN size that contains the circuitry and components for the functions of the mobile audio-video receiver 100, a front panel 102 at the front surface 101_{FS} of the base 101, and a display screen 103 is positioned at the center of the front panel 102. The front panel 102 can be a sliding front panel that slides down and out from base 101 to allow access to a DVD player behind the front panel 102 in the front surface 101_{FS}.

The display screen 103 has sufficient size, color rendering capability, and resolution to display video images. For example, the display screen can display navigational maps, movies, satellite television, video from a back-up camera or video input from other types of video output devices. Further, the display screen 103 can be a touch-panel display screen so that additional controls can be implemented.

Along with the display screen 103, the front panel 102 has numerous controls for operating the related art mobile audio-video receiver. As shown in FIG. 1, the front panel 102 includes four function buttons 104 positioned at corners of the front panel 102, a four-way rocker with a center button 105 positioned on one side of the display screen 103, a spinning controller with a center button 106 positioned on the other side of the display screen 103, and additional function buttons 107 surrounding the four-way rocker with the center button 105 and the spinning controller with the center button 106. The front panel 102 can also includes index control buttons 108 having functions commensurate to tabs on the display screen 103 that correspond to each of the index control buttons 108.

Although a double-DIN mobile audio-video receiver has a sufficient surface area on the front panel for a display screen and control button, a double-DIN mobile audio-video receiver does not fit into many vehicles. Although the double-DIN size is becoming more prevalent, many vehicles are still being manufactured to receive a single-DIN sized receiver. The front panel of a single-DIN sized receiver does not have enough surface area for both control buttons and a display screen, which is sufficiently large enough for viewing video images by both the driver and the passenger.

FIG. 2 is a front view of a related art mobile audio-video receiver with a sliding front-face hidden display. As shown in FIG. 2, the mobile audio-video receiver 200 includes a base 201 having a single-DIN size that contains the circuitry and components for the functions of the mobile audio-video receiver 200 and a front panel 202 at the front surface 201 FS of the base 201. The front panel 202 is a sliding front panel that slides down and out from the base 201 to allow viewing of a display screen 203 on the front surface 201_{FS} of the base 201. The display screen 203 behind the front panel 202 can be a touch-panel display screen. Control buttons for the receiver 200, such as a four-way rocker with a center button, a spinning controller with a center button and/or function buttons are positioned on the front panel 202. Since the front panel 202 slides down and away from the base 201, there is sufficient surface area on the front panel 202 for control buttons and a display screen 203 having a size sufficient for viewing can be provide on the front surface 201_{FS} of the base 201.

As discussed above, a related art mobile audio-video receiver is usually mounted in the dash between where the driver is positioned and where a passenger can be positioned. Unless the passenger and/or the driver lean over in front of the related art mobile audio-video receiver, neither the driver nor the passenger are directly in front of the related art mobile audio-video receiver. In the cases of both the single-DIN and the double-DIN sized mobile audio-video receivers of the related art, the display screen is viewed at an off-angle by both the passenger and the driver. Thus, the display screens of both of the related art mobile audio-video receivers have a wide viewing angle for viewing by both the passenger and the driver. Accordingly, the passenger and the driver will be viewing the display screen of the related art mobile audio-video receiver near the boundaries of the wide viewing angle of the display screen where the picture quality begins to degrade.

In most jurisdictions, drivers are prohibited from viewing video images that do not relate to driving. For example, drivers are allowed to view navigational information or a back-up image from a back-up camera while driving. However, drivers are not allowed to view satellite television, movies or other non-driving related images while driving. Some jurisdictions even prohibit drivers from being able to see the display screen that is showing non-driving related images. Because of such prohibitions and the placement of the related art mobile audio-video receiver in the dash between the driver and the passenger so that both the driver and the passenger can see the displayed images, the passenger is prevented from watching non-driving related video images.

### SUMMARY OF THE INVENTION

Accordingly, the present invention is directed to a mobile audio-video receiver with a movable display that substantially obviates one or more of the problems due to limitations and disadvantages of the related art.

An object of the present invention is to improve the viewing position of a display on a mobile audio-video receiver for a driver.

An object of the present invention is to improve the viewing position of a display on a mobile audio-video receiver for a passenger.

Another object of the present invention is to increase the surface area for control buttons on a mobile audio-video receiver.

Another object of the present invention is to increase the display surface area on a mobile audio-video receiver.

An object of the present invention is to provide a display on a mobile audio-video receiver for a driver.

An object of the present invention is to provide a display on a mobile audio-video receiver for a passenger.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a mobile audio-video receiver with a movable display includes: a base containing circuitry; a front surface of the base defined by a first long side of the base having a first direction, a second long side of the base opposite to the first long side and having a second direction, a first short side of the base and a second short side of the base opposite to the first short side; and a door-display having a first display screen and hingedly attached to the base with a first hinge axis crossing the first and second directions.

In another aspect, a mobile audio-video receiver with a movable display includes: a base for containing circuitry; a front surface of the base defined by a first long side of the base, a second long side of the base opposite to the first long side, a first short side of the base and a second short side of the base opposite to the first short side; a control for the mobile audio-video receiver positioned on the front surface of the base; and a door-display hingedly attached to the base with a hinge axis at the first short side.

In another aspect, a mobile audio-video receiver with a movable display includes: a base containing circuitry; a front surface of the base having controls for the mobile audio-video receiver; a first door-display having a first display screen and hingedly attached to the base; and a second door-display having a second display screen and hingedly attached to the base.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a front view of a related art mobile audio-video receiver with a front-face display;

FIG. 2 is a front view of a related art mobile audio-video receiver with a sliding front-face hidden display;

FIG. 3A is a front view of a mobile audio-video receiver having a center control console and closed door-displays according to a first embodiment of the present invention;

FIG. 3B is a front view of the mobile audio-video receiver shown in FIG. 3A with opened door-displays;

FIG. 3C is a front view of the mobile audio-video receiver shown in FIG. 3A with flipped and closed door-displays;

FIG. 4A is a top view of perspectives for a driver and a passenger of a mobile audio-video receiver with opened door-displays according to an embodiment of the present invention;

FIG. 4B is a side view of the perspective for a passenger of a mobile audio-video receiver having an opened door-display according to an embodiment of the present invention;

FIG. 5A is a front view of a mobile audio-video receiver having closed door-displays with controls adjacent to the displays on the door-displays according to a second embodiment of the present invention;

FIG. 5B is a front view of the mobile audio-video receiver shown in FIG. 5A with opened door-displays;

FIG. 6A is a front view of a mobile audio-video receiver having closed door-displays with one of the door-displays having only controls on one side of the door-display and a display on the other side of the door-display according to a third embodiment of the present invention; and

FIG. 6B is a front view of the mobile audio-video receiver shown in FIG. 6A with opened door-displays.

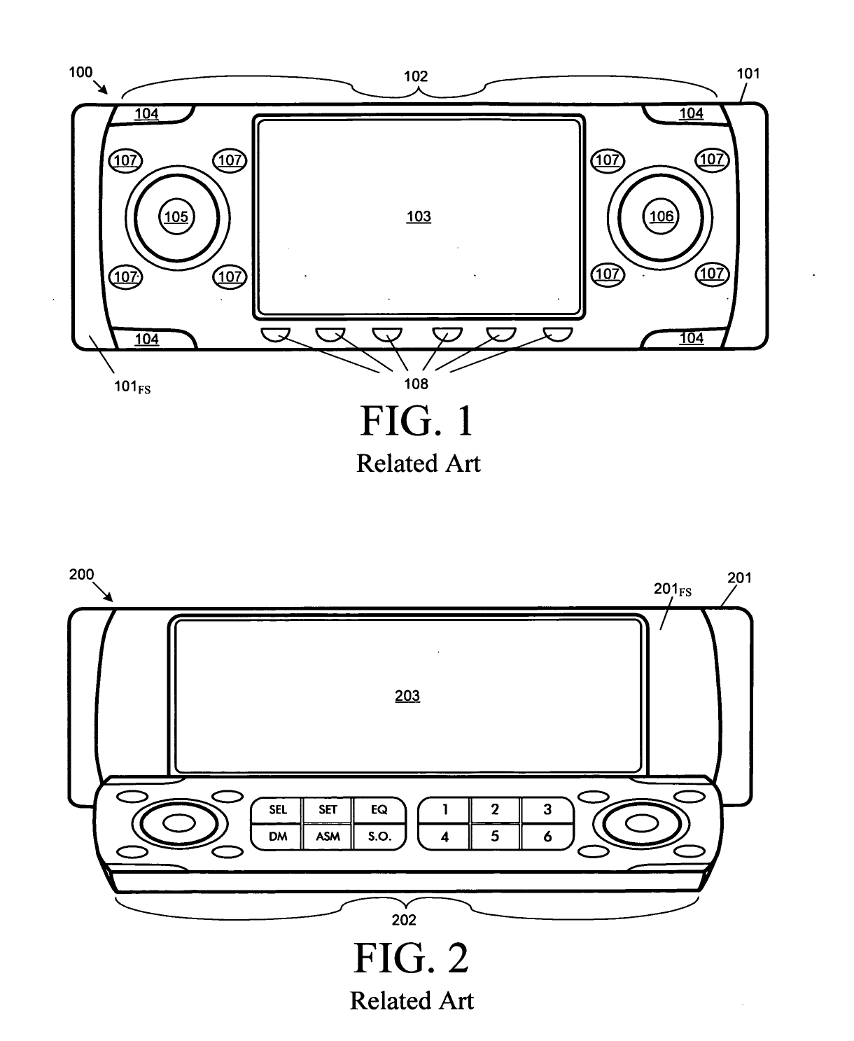

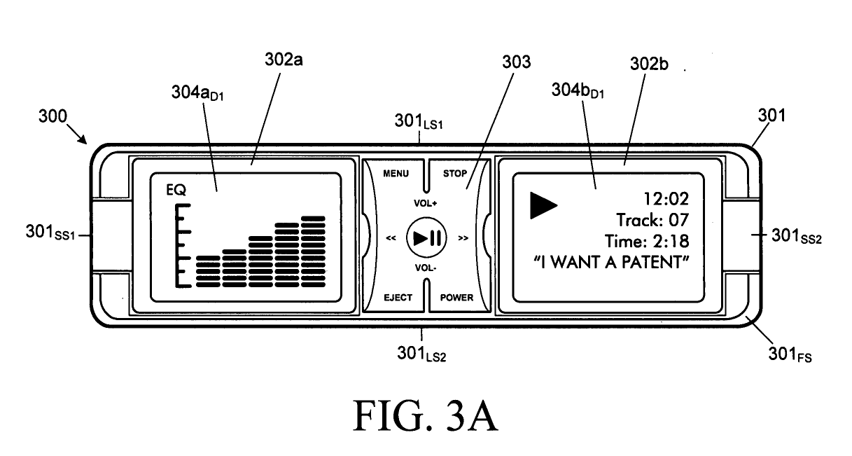

### DETAILED DESCRIPTION OF THE PREFERRED EMBODIMENTS

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

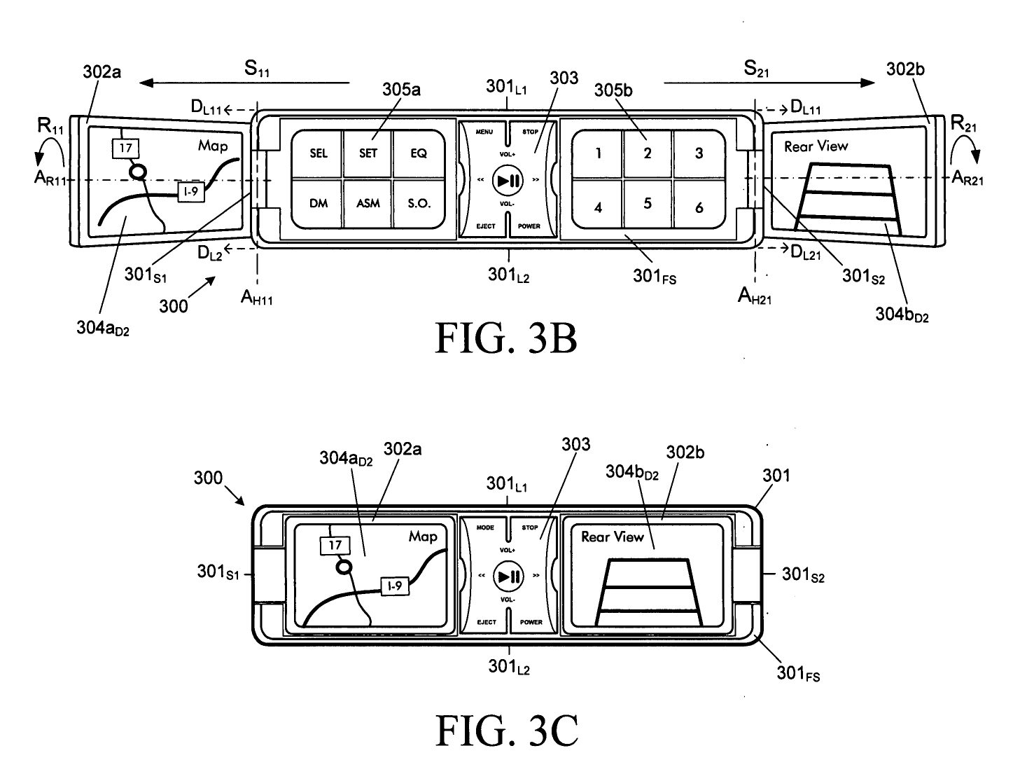

FIG. 3A is a front view of a mobile audio-video receiver having a center control console and closed door-displays according to a first embodiment of the present invention. As shown in FIG. 3A, the mobile audio-video receiver 300 includes a single-DIN base 301 that contains the circuitry to perform the functions of the mobile audio-video receiver 300, a first door-display 302a at one side of the base 301, a second door-display 302b at another side of the base 301, and a center control 303 for the receiver 300 positioned on a front surface 301_{FS} of the base 301 between the first and second door-displays 302a and 302b. The center control 303 can be an 8-way rocker with a center button. The front surface 301_{FS} of the base 301 is defined by opposing first and second long sides 301_{L1} and 301_{L2} of the base 301, and opposing first and second short sides 301_{S1} and 301_{S2} of the base 301.

The first and second door-displays 302a and 302b in FIG. 3A are both closed. The closed position for a door-display is when the door-display is positioned adjacent to and over the front surface 301_{FS} of the base 301. A first display screen 304a_{D1} is on the outside surface of the first door-display 302a when the first door-display 302a is in the closed position. A second display screen 304b_{D1} is on the outside surface of the second door-display 302b when the second door-display 302b is in the closed position.

As shown in FIG. 3A, the first and second display screens 304a_{D1} and 304b_{D1} can be mono-color display screens for showing information with regard to operations of the mobile audio-video receiver 300. In the alternative, one of or both of the first and second display screens 304a_{D1} and 304b_{D1} can be a multi-color display screen for showing information with regard to operations of the mobile audio-video receiver 300 as well as other types of information related to driving. The first and second display screens 304a_{D1} and 304b_{D1} can both have a wide viewing angle so that both the driver on one side of the base 301 and the passenger on the other side of the base 301 can see the information displayed on the first and second display screens 304a_{D1} and 304b_{D1}. Further, either one of or both of the first and second display screens 304a_{D1} and 304b_{D1} can be a touch-panel display screen.

FIG. 3B is a front view of the mobile audio-video receiver shown in FIG. 3A with opened door-displays. As shown in FIG. 3B, the first and second door-displays 302a and 302b are hingedly attached to the base 301. The first door-display 302a is hingedly attached to the base 301 with a first hinge axis A_{H11} adjacent to the first short side 301_{S1}. The first hinge axis A_{H11} crosses the first direction D_{L11} of the first long side 301_{L1} and the second direction D_{L21} of the second long side 301_{L2}. The second door-display 302b is hingedly attached to the base 301 with a second hinge axis A_{H21} adjacent to the second short side 301_{S2}. The second hinge axis A_{H21} crosses the first direction D_{L11} of the first long side 301_{L1} and the second direction D_{L21} of the second long side 301_{L2}.

The first and second door-displays 302a and 302b in FIG. 3B are both opened. The open position for a door-display is when the door-display is positioned away from the front surface 301_{FS} of the base 301. More specifically, the first door-display 302a is swung out S₁₁ about the first hinge axis A_{H11} and the second door-display 302b is swung out S₂₁ about the second hinge axis A_{H21}.

As shown in FIG. 3B, a first set of controls 305a for the receiver 300 is on an area of the front surface 301_{FS} that is covered by the first door-display 302a when the first door-display 302a is closed. Further, a second set of controls 305b for receiver 300 is on an area of the front surface 301_{FS} that is covered by the second door-display 302b when the second door-display 302b is closed. The first and second sets of controls 305a and 305b can be matrices of buttons.

A third display screen 304a_{D2} is on the inside surface of the first door-display 302a when the first door-display 302a is in the open position. A fourth display screen 304b_{D2} is on the inside surface of the second door-display 302b when the second door-display 302b is in the open position. The third and fourth display screens 304a_{D2} and 304b_{D2} can be multi-color display screens for showing information with regard to operations of the mobile audio-video receiver 300 as well as other types of information related to driving. The third and fourth display screens 304a_{D2} and 304b_{D2} can both have a wide viewing angle. Further, any one of the first, second, third and fourth display screens 304a_{D1}, 304a_{D2}, 304b_{D1} and 304b_{D2} can be a touch-panel display screen for controlling functions of the receiver 300.

As shown in FIG. 3B, the first door-display 302a can rotate R₁₁ about a first rotational axis A_{R11} that crosses the first hinge axis A_{H11}. Further, the second door-display 302b can rotate R₂₁ about a second rotational axis A_{R21} that crosses the first hinge axis A_{H11}. In the alternative, the first and second rotational axes A_{R11} and A_{R21} of the first and second door-displays 302a and 302b can intersect the first and second hinge axes A_{H11} and A_{H21} instead of just crossing the first and second hinge axes A_{H11} and A_{H21}.

FIG. 3C is a front view of the mobile audio-video receiver shown in FIG. 3A with flipped and closed door-displays. As shown in FIG. 3C, the first door-display 302a can rotate more than 180° about the first rotational axis A_{R11} such that the third display screen 304a_{D2} can be on the outside surface of the first door-display 302a when the first door display 302a is closed, as shown in FIG. 3C. Similarly, the second door-display 302b can rotate more than 180° about the second rotational axis A_{R21} such that the fourth display screen 304b_{D2} can be on the outside surface of the second door-display 302b when the second door display 302b is closed, as shown in FIG. 3C. In the alternative, either one or both of the door-displays can have a rotational limit of 45° that prevents a door display from being flipped over and closed but simplifies wiring requirements between the door-display and the base of the mobile audio-video receiver.

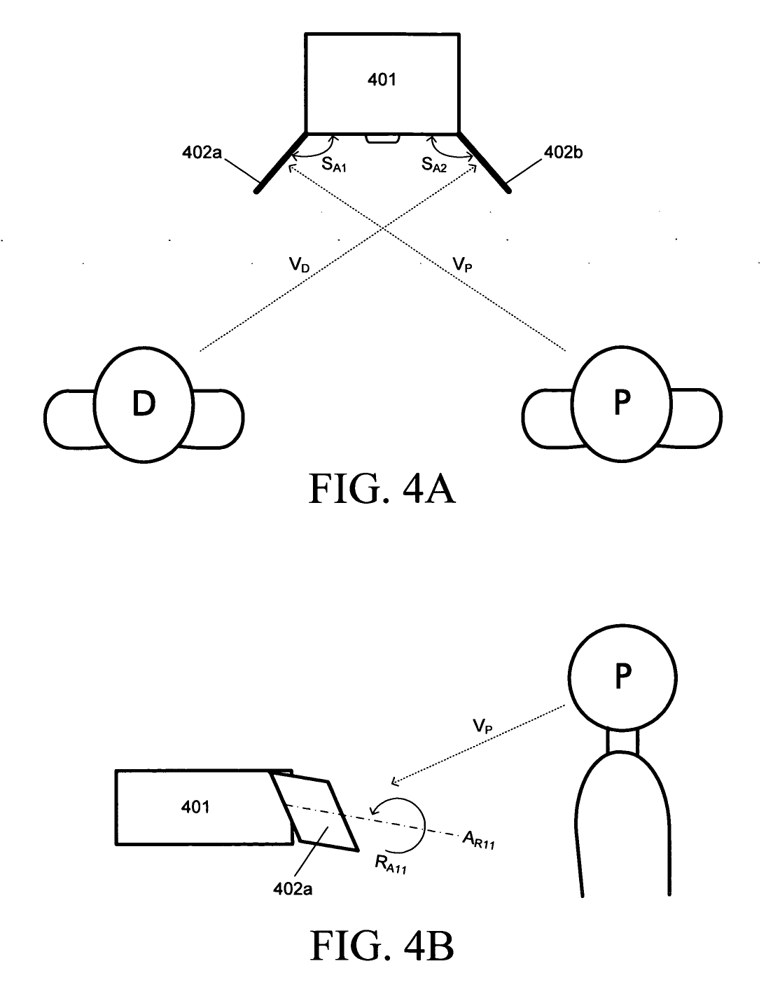

FIG. 4A is a top view of perspectives for a driver and a passenger of a mobile audio-video receiver with opened door-displays according to an embodiment of the present invention. As shown in FIG. 4A, the first door-display 402a can be swung out from the base 401 to position a display screen (not shown) on the first door-display 402a for viewing V_{P} by the passenger P. Further, the second door-display 402b can be swung out to position a display screen (not shown) on the second door-display 402b for viewing V_{D} by the driver D. The first door-display 402a has a first swing-out angle S_{A1}. The second door-display 402b has a second swing-out angle S_{A2}. The first and second swing-out angles S_{A1} and S_{A2} can be within a range of about 0-220°, for example.

The first swing-out angle S_{A1} of the first door-display 402a having display screen for viewing V_{P} by the passenger P can have a limited range of about 0-145°. The limited range of the first door-display 402a having display screen for viewing V_{P} by the passenger P prevents the driver D from being able to see the display screen that a passenger P is viewing V_{P}. Thus, the passenger P can view non-driving related video, such as movies or television, while the driver D is unable to view the non-driving related video. In addition, the display screen that the passenger P is viewing V_{P} can be a narrow viewing-angle display screen to further prevent the driver D from being able to view non-driving related video. For example, the narrow viewing-angle display screen can have a viewing angle of less than about 155°.

FIG. 4B is a side view of the perspective for a passenger of a mobile audio-video receiver having an opened door-display according to an embodiment of the present invention. As discussed above, a door-display can rotate about a rotational axis that crosses the hinge axis of the door-display. As shown in FIG. 4B, the rotation R_{A1} capability of the first door-display 402a can be used to position a display screen (not shown) on the first door-display 402a for viewing V_{P} by the passenger P.

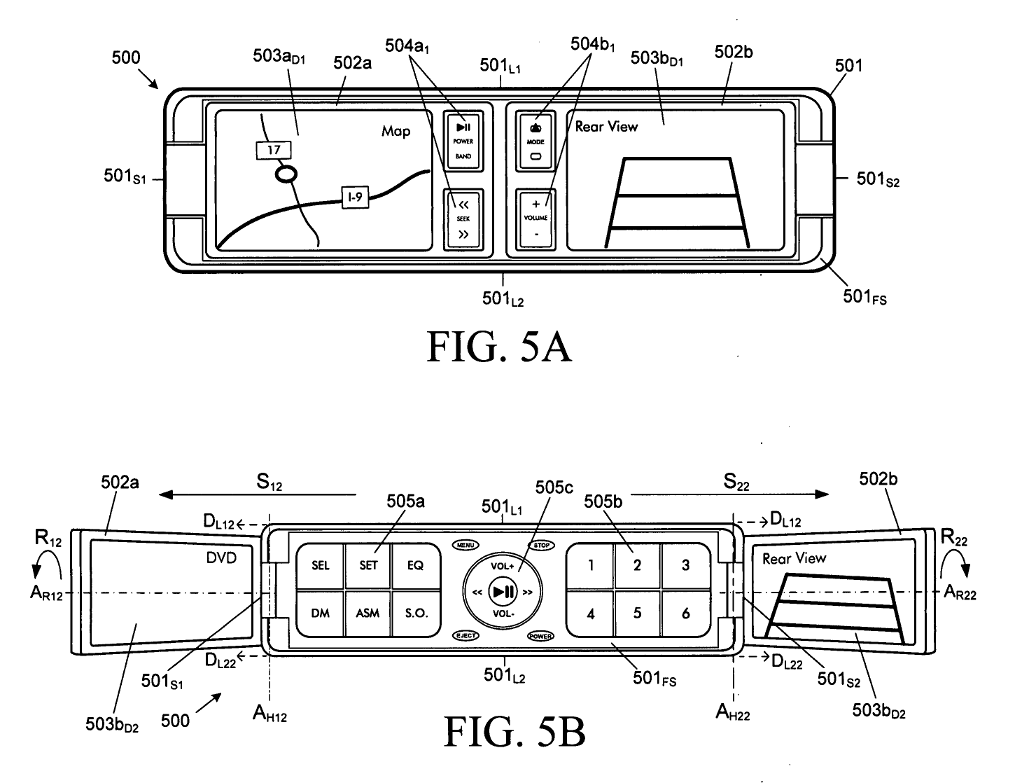

FIG. 5A is a front view of a mobile audio-video receiver having closed door-displays with controls adjacent to the displays on the door-displays according to a second embodiment of the present invention. As shown in FIG. 5A, the mobile audio-video receiver 500 includes a single-DIN base 501 that contains the circuitry to perform the functions of the mobile audio-video receiver 500, a first door-display 502a at one side of the base 501 and a second door-display 502b at another side of the base 501. The front surface 501_{FS} of the base 501 is defined by opposing first and second long sides 501_{L1} and 501_{L2} of the base 501, and opposing first and second short sides 501_{S1} and 501_{S2} of the base 501.

The first and second door-displays 502a and 502b in FIG. 5A are both closed. The closed position for a door-display is when the door-display is positioned adjacent to and over the front surface 501_{FS} of the base 501. A first display screen 503a_{D1} is on the outside surface of the first door-display 502a when the first door-display 502a is in the closed position. A first set of controls 504a₁ for the receiver 500 is adjacent to the first display screen 503a_{D1} on the outside surface of the first door-display 502a when the first door-display 502a is in the closed position. A second display screen 503b_{D1} is on the outside surface of the second door-display 502b when the second door-display 502b is in the closed position. A second set of controls 504b₁ for the receiver 500 is adjacent to the second display screen 503b_{D1} on the outside surface of the second door-display 502b when the second door-display 502b is in the closed position. The first and second sets of controls 504a₁ and 504b₁ can be rocker switches.

As shown in FIG. 5A, the first and second display screens 503a_{D1} and 503b_{D1} can be multi-color display screens for showing information with regard to operations of the mobile audio-video receiver 500 and/or driving related information. In the alternative, one of or both of the first and second display screens 503a_{D1} and 503b_{D1} can be a mono-color display screen for showing information with regard to operations of the mobile audio-video receiver 500 as well as other types of information related to driving. The first and second display screens 503a_{D1} and 503b_{D1} can both have a wide viewing angle so that both the driver on one side of the base 501 and the passenger on the other side of the base 501 can see the information displayed on the first and second display screens 503a_{D1} and 503b_{D1}.

FIG. 5B is a front view of the mobile audio-video receiver shown in FIG. 5A with opened door-displays. As shown in FIG. 5B, the first and second door-displays 502a and 502b are hingedly attached to the base 501. The first door-display 502a is hingedly attached to the base 501 with a first hinge axis A_{H12} adjacent to the first short side 501_{S1}. The first hinge axis A_{H12} crosses the first direction D_{L12} of the first long side 501_{L1} and the second direction D_{L22} of the second long side 501_{L2}. The second door-display 502b is hingedly attached to the base 501 with a second hinge axis A_{H12} adjacent to the second short side 501_{S2}. The second hinge axis A_{H22} crosses the first direction D_{L12} of the first long side 501_{L1} and the second direction D_{L22} of the second long side 501_{L2}.

The first and second door-displays 502a and 502b in FIG. 5B are both opened. The open position for a door-display is when the door-display is positioned away from the front surface 501_{FS} of the base 501. More specifically, the first door-display 502a is swung out S₁₂ about the first hinge axis A_{H12} and the second door-display 502b is swung out S₂₂ about the second hinge axis A_{H22}.

As shown in FIG. 5B, a third set of controls 505a for the receiver 500 is on an area of the front surface 501_{FS} that is covered by the first door-display 502a when the first door-display 502a is closed. Similarly, a fourth set of controls 505b for the receiver 500 is on an area of the front surface 501_{FS} that is covered by the second door-display 502b when the second door-display 502b is closed. Furthermore, a fifth set of controls 505c for the receiver 500 is on an area of the front surface 501_{FS} that is covered by both the first and second door-displays 502a and 502b when the second door-display 502b is closed. The third and fourth sets of controls 505a and 505b can be matrices of buttons. The fifth set of controls 505c can be a four-way rocker with a center button surrounded by other buttons.

A third display screen 503a_{D2} is on the inside surface of the first door-display 502a when the first door-display 502a is in the open position. A fourth display screen 503b_{D1} is on the inside surface of the second door-display 502b when the second door-display 502b is in the open position. The third and fourth display screens 503a_{D2} and 503b_{D2} can be multi-color display screens for showing information with regard to operations of the mobile audio-video receiver 500 as well other types of information related to driving. The third display screen 503a_{D2} can also display video images, such as movies or television. Further, the third display screen 503a_{D2} can have a narrower viewing angle than any one of the first, third and fourth display screens 503a_{D1}, 503b_{D1} and 503b_{D2}. The third and fourth display screens 503a_{D2}and 503b_{D2} can each have a larger size than any one of the first and second display screens 503a_{D1} and 503b_{D1}, since there are no controls adjacent to the third and fourth display screens 503a_{D2} and 503b_{D2}. Further, any one of the first, second, third and fourth display screens 503a_{D1}, 503a_{D2}, 503b_{D1} and 503b_{D2} can be a touch-panel display screen for controlling functions of the receiver 500.

As shown in FIG. 5B, the first door-display 502a can rotate R₁₂ about a first rotational axis A_{R12} that crosses the first hinge axis A_{H11}. Further, the second door-display 502b can rotate R₂₂ about a second rotational axis A_{R22} that crosses the first hinge axis A_{H12}. In the alternative, the first and second rotational axes A_{R11} and A_{R22} of the first and second door-displays 502a and 502b can intersect the first and second hinge axes A_{H12} and A_{H22} instead of just crossing the first and second hinge axes A_{H12} and A_{H22}.

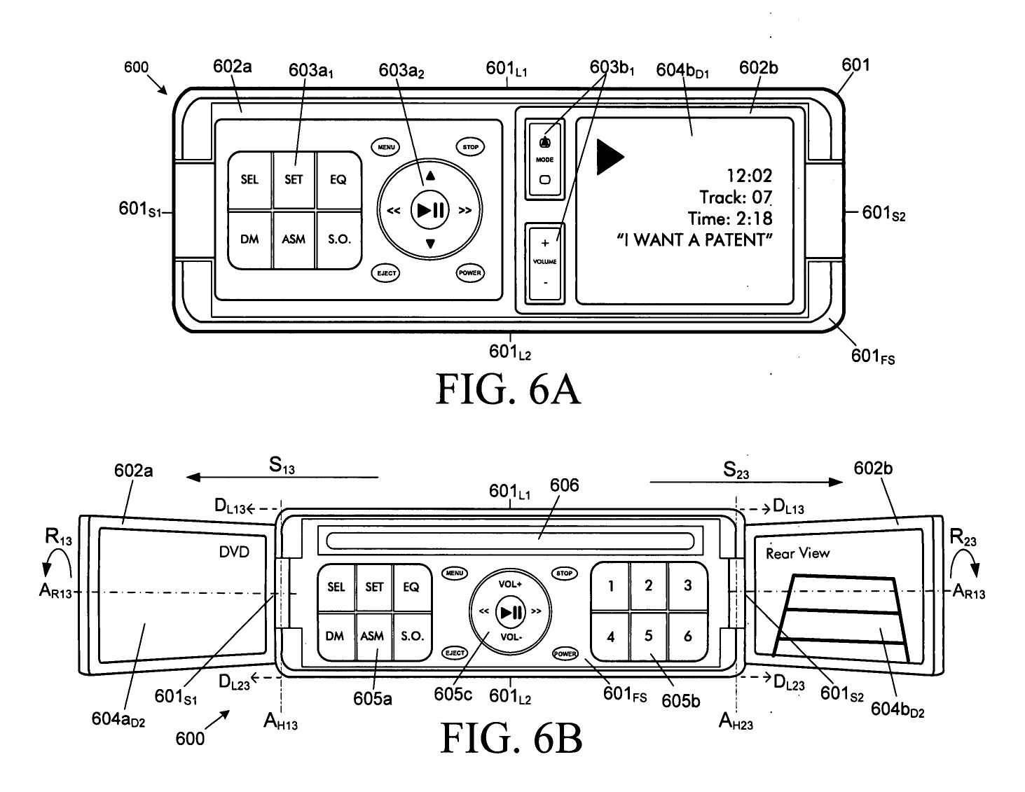

FIG. 6A is a front view of a mobile audio-video receiver having closed door-displays with one of the door-displays having only controls on one side of the door-display and a display on the other side of the door-display according to a third embodiment of the present invention. As shown in FIG. 6A, the mobile audio-video receiver 600 includes a double-DIN base 601 that contains the circuitry to perform the functions of the mobile audio-video receiver 600, a first door-display 602a at one side of the base 601 and a second door-display 602b at another side of the base 601. The front surface 601_{FS} of the base 601 is defined by opposing first and second long sides 601_{L1} and 601_{L2} of the base 601, and opposing first and second short sides 601_{S1} and 601_{S2} of the base 601.

The first and second door-displays 602a and 602b in FIG. 6A are both closed. The closed position for a door-display is when the door-display is positioned adjacent to and over the front surface 601_{FS} of the base 601. First and second sets of controls 603a₁ and 603a₂ for the receiver 600 are on the outside surface of the first door-display 602a when the first door-display 602a is in the closed position. A first display screen 604b_{D1} is on the outside surface of the second door-display 602b when the second door-display 602b is in the closed position. A third set of controls 603b₁ for the receiver 600 is adjacent to the first display screen 604b_{D1} on the outside surface of the second door-display 602b when the second door-display 602b is in the closed position. The first set of controls 603a₁ can be a matrices of buttons. The second set of controls 603b₁ can be a four-way rocker with a center button surround by buttons.

As shown in FIG. 6A, the first display screen 604b_{D1} can be a multi-color display screen for showing information with regard to operations of the mobile audio-video receiver 600 and/or driving related information. In the alternative, the first display screen 604b_{D1} can be a mono-color display screen for showing information with regard to operations of the mobile audio-video receiver 600 as well other types of information related to driving. The first display screen 604b_{D1} can have a wide viewing angle so that both the driver on one side of the base 601 and the passenger on the other side of the base 601 can see the information displayed on the first display screen 604b_{D1}.

FIG. 6B is a front view of the mobile audio-video receiver shown in FIG. 6A with opened door-displays. As shown in FIG. 6B, the first and second door-displays 602a and 602b are hingedly attached to the base 601. The first door-display 602a is hingedly attached to the base 601 with a first hinge axis A_{H13} adjacent to the first short side 601_{S1}. The first hinge axis A_{H13} crosses the first direction D_{L13} of the first long side 601_{L1} and the second direction D_{L23} of the second long side 601_{L2}. The second door-display 602b is hingedly attached to the base 601 with a second hinge axis A_{H13} adjacent to the second short side 601_{S2}. The second hinge axis A_{H23} crosses the first direction D_{L13} of the first long side 601_{L1} and the second direction D_{L23} of the second long side 601_{L2}.

The first and second door-displays 602a and 602b in FIG. 6B are both opened. The open position for a door-display is when the door-display is positioned away from the front surface 601_{FS} of the base 601. More specifically, the first door-display 602a is swung out S₁₃ about the first hinge axis A_{H13} and the second door-display 602b is swung out S₂₃ about the second hinge axis A_{H23}.

As shown in FIG. 6B, a fourth set of controls 605a for the receiver 600 is on an area of the front surface 601_{FS} that is covered by the first door-display 602a when the first door-display 602a is closed. Further, a fifth set of controls 605b for the receiver is on an area of the front surface 601_{FS} that is covered by the second door-display 602b when the second door-display 602b is closed. Furthermore, a sixth set of controls 605c for the receiver 600 is on an area of the front surface 601_{FS} that is covered by both the first and second door-displays 602a and 602b when the second door-display 602b is closed. The fourth and fifth sets of controls 605a and 605b can be matrices of buttons. The sixth set of controls 605c can be a four-way rocker with a center button surrounded by other buttons. The front surface 601_{FS} can also have an area for the slot 606 of a digital video disk (DVD) player in the base 601.

A second display screen 604a_{D2} is on the inside surface of the first door-display 602a when the first door-display 602a is in the open position. A third display screen 604b_{D2} is on the inside surface of the second door-display 602b when the second door-display 602b is in the open position. The second and third display screens 604a_{D2} and 604b_{D2} can be multi-color display screens for showing information with regard to operations of the mobile audio-video receiver 600 as well other types of information related to driving. The second display screen 604a_{D2} can also display video images, such as movies or television. Further, the second display screen 604a_{D2} can have a narrower viewing angle than any one of the first and third display screens 604b_{D1} and 604b_{D2}. The second and third display screens 604a_{D2} and 604b_{D2} can each have a larger size than the first display screen 604b_{D1}, since there are no controls adjacent to the second and third display screens 604a_{D2} and 604b_{D2}. Further, any one of the first, second and third display screens 604a_{D1}, 604b_{D1} and 604b_{D2} can be a touch-panel display screen for controlling functions of the receiver 600.

As shown in FIG. 6B, the first door-display 602a can rotate R₁₃ about a first rotational axis A_{R13} that crosses the first hinge axis A_{H13}. Further, the second door-display 602b can rotate R₂₃ about a second rotational axis A_{R23} that crosses the first hinge axis A_{H13}. In the alternative, the first and second rotational axes A_{R13} and A_{R23} of the first and second door-displays 602a and 602b can intersect the first and second hinge axes A_{H13} and A_{H23} instead of just crossing the first and second hinge axes A_{H13} and A_{H23}.

It will be apparent to those skilled in the art that various modifications and variations can be made in the mobile audio-video receiver with a movable display of the present invention without departing from the spirit or scope of the invention. Thus, it is intended that the present invention cover the modifications and variations of this invention provided they come within the scope of the appended claims and their equivalents.

What is claimed is:

1. A mobile audio-video receiver with a movable display, comprising:
a base for containing circuitry;
a front surface of the base defined by a first long side of the base having a first direction, a second long side of the base opposite to the first long side and having a second direction, a first short side of the base and a second short side of the base opposite to the first short side; and
a door-display having a first display screen and hingedly attached to the base with a first hinge axis crossing the first and second directions.

2. The mobile audio-receiver according to claim 1, further comprising a control for the mobile audio-video receiver positioned on the front surface of the base;

3. The mobile audio-receiver according to claim 1, wherein the door-display can rotate about a rotational axis that crosses the first hinge axis.

4. The mobile audio-receiver according to claim 1, further comprising another door-display having a second display screen and is hingedly attached to the base with a second hinge axis crossing the first and second directions.

5. The mobile audio-receiver according to claim 4, wherein a control for the mobile audio-video receiver is positioned between the first and second display screens.

6. The mobile audio-receiver according to claim 1, further comprising a control for the mobile audio-video receiver positioned on the door-display adjacent to the first display screen.

7. The mobile audio-receiver according to claim 1, wherein the first display screen is on a first surface of the door-display and a control for the mobile audio-video receiver is on a second surface of the door-display opposite to the first surface.

8. The mobile audio-receiver according to claim 1, wherein the first display screen is on a first surface of the door-display and a second display screen is on a second surface of the door-display opposite to the first surface.

9. A mobile audio-video receiver with a movable display, comprising:
a base for containing circuitry;
a front surface of the base defined by a first long side of the base, a second long side of the base opposite to the first long side, a first short side of the base and a second short side of the base opposite to the first short side;
a control for the mobile audio-video receiver positioned on the front surface of the base; and
a door-display hingedly attached to the base with a first hinge axis adjacent to the first short side.

10. The mobile audio-receiver according to claim 9, wherein the door-display is rotational about a rotational axis that crosses the first hinge axis.

11. The mobile audio-receiver according to claim 9, further comprising another door-display having a second display screen and hingedly attached to the base with a second hinge axis at the second short side.

12. The mobile audio-receiver according to claim 11, further comprising another control for the mobile audio-video receiver positioned between the first and second display screens.

13. The mobile audio-receiver according to claim 9, wherein another control for the mobile audio-video receiver is positioned on the door-display adjacent to the first display screen.

14. The mobile audio-receiver according to claim 9, wherein the first display screen is on a first surface of the door-display and another control for the mobile audio-video receiver is on a second surface of the door-display opposite to the first surface.

15. The mobile audio-receiver according to claim 9, wherein the first display screen is on a first surface of the door-display and a second display screen is on a second surface of the door-display opposite to the first surface.

16. A mobile audio-video receiver with movable displays, comprising:
a base for containing circuitry;
a front surface of the base having a control for the mobile audio-video receiver;
a first door-display having a first display screen and hingedly attached to the base; and
a second door-display having a second display screen and hingedly attached to the base.

17. The mobile audio-receiver according to claim 16, wherein the first display screen is on a first surface of the first door-display and a third display screen is on a second surface of the first door-display opposite to the first surface.

18. The mobile audio-receiver according to claim 17, wherein the second display screen is on a third surface of the second door-display and a fourth display screen is on a fourth surface of the second door-display opposite to the third surface.

19. The mobile audio-receiver according to claim 16, further comprising another control for the mobile audio-video receiver positioned on the first door-display adjacent to the first display screen.

20. The mobile audio-receiver according to claim 16, wherein the first display screen is on a first surface of the first door-display and another control for the mobile audio-video receiver is on a second surface of the first surface door-display opposite to the first surface.
